(19) United States
(12) Patent Application Publication
(10) Pub. No.: US 2011/0259354 A1
(43) Pub. Date: Oct. 27, 2011

(54) Method for The Manufacture of a Multi-Layer Substrate Which Can be Bonded to The Skin to Form Self-Adhesive Hair Prostheses and Multi-Layer Prostheses so Obtained

(76) Inventor: Massimiliano Delli, Province of Firenze (IT)

(21) Appl. No.: 13/130,823

(22) PCT Filed: Dec. 1, 2009
(86) PCT No.: PCT/EP09/66118

§ 371 Date: Jul. 13, 2011

(30) Foreign Application Priority Data
Dec. 2, 2008 (IT) GE2008A000100

(51) Int. Cl. A41G 3/00; B32B 38/00; B32B 37/02; B32B 37/14; C09J 1/00; B32B 37/12

(52) U.S. Cl. 132/53; 523/118; 156/327; 156/212; 156/72; 156/332

(57) ABSTRACT

Method for manufacturing bonding systems for hair prostheses which makes it possible to produce self-adhesive prostheses. The process comprises preparing a thin membrane, from 20 to 80 microns, in a single-spreading operation and from 100 to 400 microns in successive spreading operations, comprising a preformed adhesive to which silver ions having an antibacterial action are added, into which microbubbles of air are blown during the mixing process. This adhesive composition is spread onto readily-removable silicone sheets which have the characteristic of being thermoformable to form caps having the shape of the user's head. The hair prosthesis is made separately by inserting hairs into a polyurethane membrane which is then attached to the adhesive membrane.

### DESCRIPTION

This invention relates to a method for the manufacture of adhesive multi-layer substrates which can be bonded to the skin to form self-adhesive hair prostheses, and multi-layer prostheses so obtained.

At the present time various types of hair prostheses which are normally used by many tens of thousands of people affected by baldness are available on the market. These prostheses can be summarily allocated to two main categories: rigid and elastic.

Rigid prostheses are characterised by a substrate of composite material (polyurethane and/or silicone) into which the hairs are inserted; these are appreciably thick and rigid, being of the order of a few millimetres. These prostheses are generally custom-made on an expanded polyurethane cast obtained by filling an impression of the user's head and matching the shape of his baldness.

Elastic prostheses are made using an extremely soft and elastic polyurethane (from 20 to 300 microns) which are suitably preformed into a cap of standard size into which the hairs are inserted. The roots of the hairs projecting from the underside are secured to the substrate by a spread layer of polyurethane which embeds them. These “standard” prostheses are suitably cut to the shape of the user's typical baldness using a cast custom-made on customer's heads with a thin film of polyethylene and an adhesive layer with a glass fibre core. The elasticity of the substrate means that the shaped prostheses can be perfectly adjusted to the surface of the head.

In both cases, for both rigid and elastic prostheses, adhesion to the user's head is achieved through an adhesive bonding system. These systems may use adhesive tape or liquid adhesive spread with a brush.

The main disadvantage of these conventional prostheses/head adhesion systems lies in the fact that in contact with sebaceous fat and the acidity of sweat the adhesive used tends to come loose, with the result that the prosthesis is progressively detached from the user's head.

For these reasons, and in addition the hygiene problems due to sebum and sweat remaining between the prosthesis and the skin, the prostheses have to be removed periodically for cleaning and replacement of the adhesive.

This “maintenance” operation, also known as the “hygienic phase”, performs the function of rendering the skin and the prosthesis hygienic.

The problems deriving from the present technological situation for hair prostheses can be summarised in the main as: adhesion time, lack of an effective transpiration system, large thicknesses and long times for the hygienic phase.

As far as adhesion times are concerned, the systems presently in use allow periods between hygienic phases which vary from a few days up to ⅔ weeks, depending upon the pH of the sweat and the amount which the user sweats. In addition to this, conventional adhesives are attacked by physiological components of the user's skin such as sweat and sebum and ultimately detach from the head and bind to the hair, giving rise to an adverse aesthetic image and wholly losing adhesion.

As far as the problem of transpiration is concerned, it is pointed out that both adhesive strips and adhesive liquids form an impermeable film on the skin which wholly prevents transpiration, holding back sebum and sweat, thus encouraging significant bacterial growth, which in addition to being unhygienic produces unpleasant smells.

As far as prostheses are concerned, it is impossible to achieve effective transpiration and sufficient drainage of sebum and sweat using present manufacturing technology. Rigid prostheses, although drilled to permit the circulation of air between the prosthesis and the hair-bearing skin, are absolutely ineffective in ensuring any transpiration. Elastic prostheses are wholly impermeable to sweat, which remains between the prosthesis and the skin, because of the polyurethane spread to fix the hairs to the substrate and the subsequent application of liquid adhesives to provide adhesion.

In addition to this, these prostheses are of substantial thickness, some 400/600 microns, while the market requires continuous reductions in thickness to achieve greater more natural hair and greater comfort for users.

Finally, present-day technology provides that the time needed for the periodical hygienic phases is approximately 50/60 minutes, in addition to the time needed to cut the hair, that is an excessively long time.

The main object of this invention is therefore to provide a substrate which can be bonded to the skin to form self-adhesive hair prostheses suitable for producing a multi-layer prosthesis capable of overcoming the abovementioned disadvantages of the prostheses currently in use.

In particular, according to a principal characteristic of this invention, it provides a method for the manufacture of a substrate which can be bonded to the skin in order to form self-adhesive hair prostheses through the use of a liquid adhesive, comprising the stages of:

adding 0% or 0.5% by weight of micronized silver powder or a stoichiometrically quantitative equivalent of Ag⁺ ions to the adhesive,

intimately mixing the Ag powder and/or the Ag⁺ ions and the adhesive,

blowing microbubbles of air into this liquid mixture during the mixing stage,

spreading the said mixture on a thermoformable silicone film which can be quite easily or readily detached with the formation of a film having thicknesses of 5 to 80 microns in a single spreading operation.

According to a further feature of the invention it provides for application of a polyurethane membrane which allows transpiration through microperforation of the same to that film, and subsequently inserting hair onto that polyurethane membrane to form the hair prosthesis, and subsequent application of the said prosthesis onto one of the previously-shaped bondable substrates.

Further features and advantages of this invention will be more apparent in the course of the following description, made with reference to the appended drawings, provided by way of a non-restrictive example of this invention, in which:

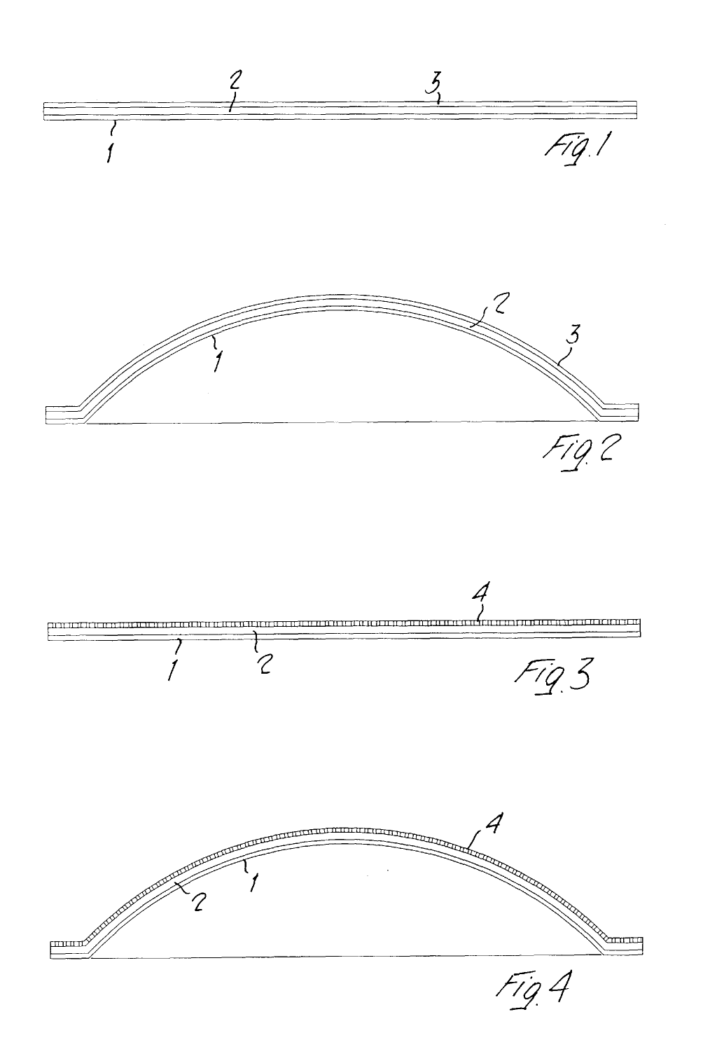

FIG. 1 diagrammatically illustrates in longitudinal cross-section a standard flat thermoformable adhesive substrate according to a first embodiment of this invention,

FIG. 2 diagrammatically illustrates the substrate in FIG. 1 after thermoforming, in axial longitudinal cross-section,

FIG. 3 diagrammatically illustrates the application of a microperforated hair membrane to a thermoformable substrate of the type in FIG. 1,

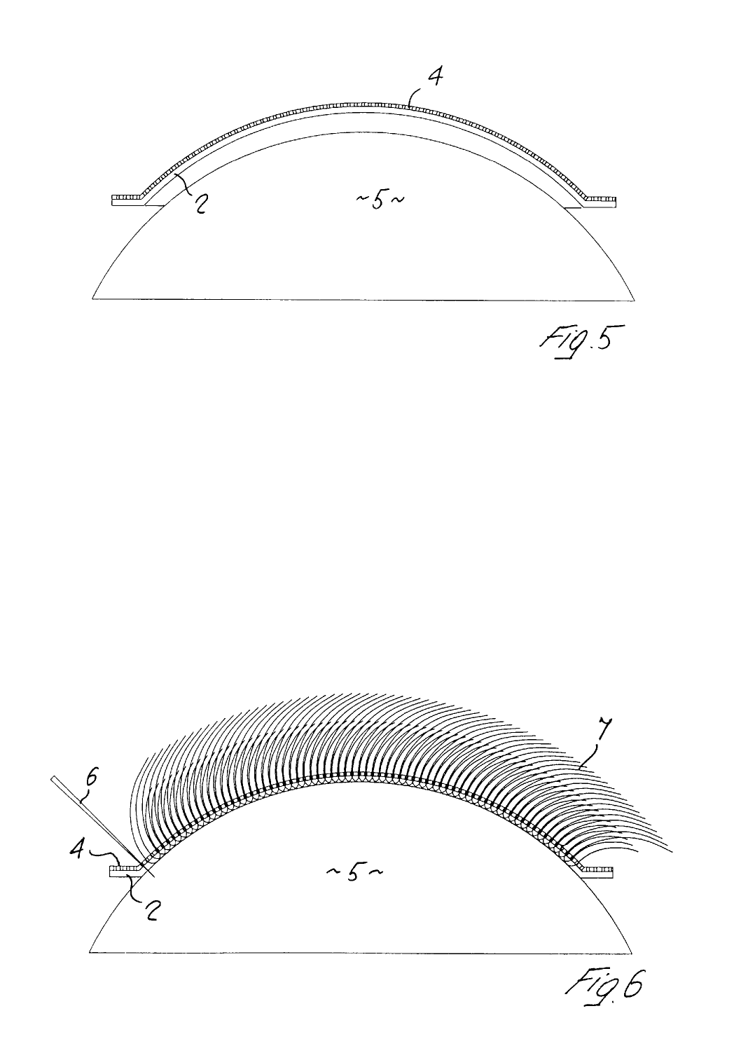

FIG. 4 diagrammatically illustrates the substrate in FIG. 3 after thermoforming,

FIG. 5 diagrammatically illustrates application of the substrate in FIG. 4 to a silicone head,

FIG. 6 diagrammatically illustrates the insertion of hair onto the membrane for hair mounted on the silicone head,

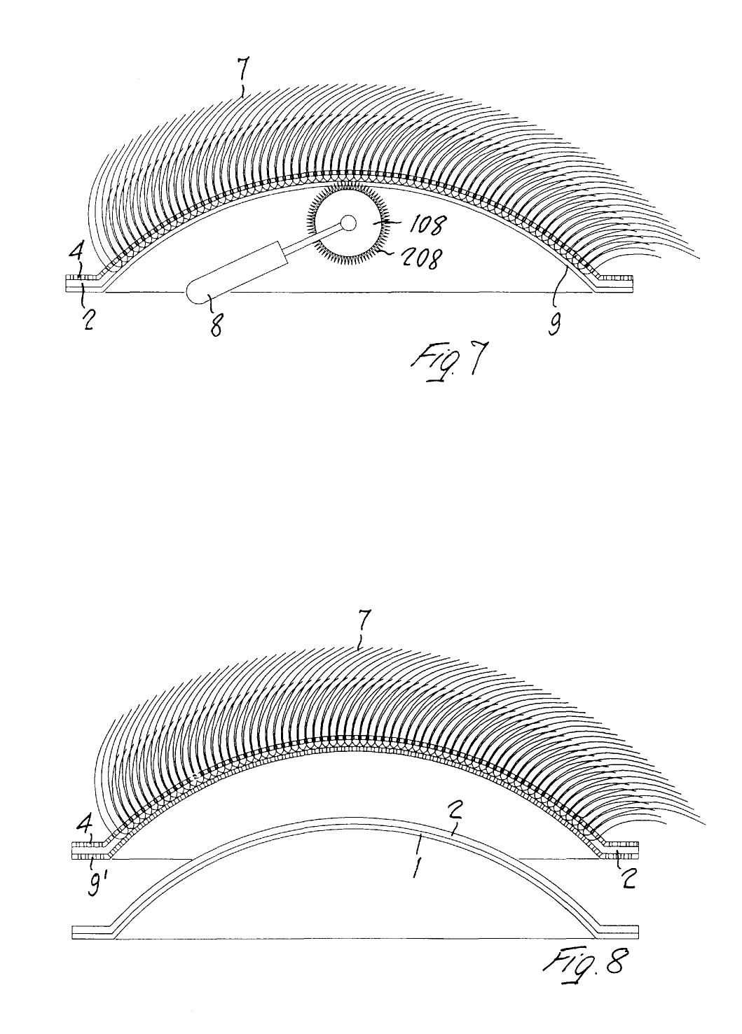

FIG. 7 diagrammatically illustrates permanent attachment of the hair to the membrane for hair in FIG. 6, with microperforation of the attachment layer,

FIG. 8 diagrammatically illustrates coupling of the membrane for hair in FIG. 6 with the substrate in FIG. 2,

FIGS. 9 to 12 diagrammatically illustrate four variants for attachment of the finished product.

With reference to FIG. 1 in the drawings, 1 indicates a silicone polyethylene film which is easily detachable and thermoformable at a temperature of approximately 60°-80° C., that is a temperature which can be obtained even using an ordinary professional phon drier. A hypoallergenic acrylic liquid adhesive, such as for example an ethyl acetate in silicone base, such as that for example known commercially as “Ultra Hold Adhesive” produced by Walker Tape Jordan, Utah, U.S.A. or a water-based polyvinyl acetate such as for example that known commercially as “Aqua Bond” or “Perfector Plus” produced by Hair & Compounds, California, U.S.A., is spread onto the said film. However, because these adhesives are wholly impermeable and prevent transpiration of any kind, encouraging bacterial growth caused by sweat and sebum, to overcome this problem it is provided according to the invention that air be blown through a microperforated tube into the liquid adhesive during the stage in which it is mixed, with the formation of microbubbles containing a mixture of air and residues of solvent vapour within them trapped within the adhesive. In addition to this, again with a view to preventing the process of bacterial growth, which apart from rendering the effect of sebum and sweat more aggressive to the adhesive, is the cause of the bad smell which is typical of prostheses used for long periods of time, an antibacterial product having a bacteriostatic action is incorporated into the adhesive. For this purpose provision is made for incorporating micronized silver powder in quantities up to 5% by weight in relation to the total weight of the adhesive, or a stoichiometrically equivalent quantity of silver ions, such as for example those provided by the product known commercially by the name of “Ionpure” produced by Ishizuka Glass Co. Ltd., Japan, is incorporated into the adhesive in the mixing stage. The liquid adhesive so obtained is spread in thicknesses varying from 20 microns to 80 microns in a single layer and from 100 microns to 400 microns in successive layers. The film so obtained is caused to pass through a stove which by heating to a temperature of 70°-80° encourages evaporation of the excess solvent from the adhesive creating an extremely dry adhesive. The layer of adhesive 2 so obtained is covered by a readily-detachable silicone film 3 allowing transpiration and is passed through a system of rollers which renders the spread material uniform, yielding a strongly adhesive membrane which is strongly resistant to aggression by sweat and sebum. To render the substrate for the prosthesis capable of transpiration, suitable equipment (see device 8 in FIG. 7) comprising a small roller 108 on which hundreds of tapering needles 208 with diamond points having a diameter of 1 micron has been produced. This roller is passed over the membrane and thus creates thousands of micropores of tapering shape which because of the elasticity of the material are normally closed and do not allow water to pass through. When the pressure due to sweat increases, as a result of their special tapering shape these microholes act like real pores and open, allowing excess sweat and sebum to escape.

At this point, to form the prosthesis the flat sheet formed in this way is cut to a suitable size for “standard” prostheses, which are suitable for almost all types of baldness; these cut portions are heated to temperatures of the order of 80° C., and using a press in the form of male and female spherical cups are curved so as to obtain a cap shape, as illustrated in FIG. 2.

At this point, as more particularly illustrated in FIGS. 3 and 4, a new sandwich of the type of that in FIG. 1 in which film 3 is replaced by a thin polyurethane membrane 4 (approximately 25 microns thick) which has been rendered capable of transpiration through microperforation as previously described is prepared. This new sandwich is again heated to approximately 80° C. and placed in a heated male/female press with a cup reproducing the shape of the head, to impart a cap shape to it, as illustrated in FIG. 4.

At this point protective film 1 is removed from the sandwich so obtained, and is positioned on a non-stick silicone head 5, as illustrated in FIG. 5, after which hairs 7 are inserted into polyurethane film 4, as illustrated in FIG. 6, using a needle 6. After this operation the prosthesis is easily removed from head 5 and a layer of liquid polyurethane is spread over the roots of the hairs to secure them. As it solidifies the polyurethane forms a film 9 which is suitably microperforated using device 8, as illustrated in FIG. 7, to restore transpiration.

At this point the product in FIG. 7 can be attached to the product in FIG. 2, from which protective liner 3 has been removed, to obtain the finished product, as shown in FIG. 8, ready for application to the user's head.

When the prosthesis is applied to the skin, a tractive force is exerted upon it, breaking the bubbles, creating openings in the adhesive, which when the prosthesis is applied to the user's head allows the skin the transpire.

The surface bubbles which remain partly closed create hemispherical cups which when applied to the skin are subjected to a pressure which allows the air present within them to escape, creating a vacuum effect like small suction cups.

In addition to this, the bubbles which remain enclosed within the adhesive, still full of air/solvent mixture, open up when attacked by sebum and/or sweat and carry out an oxidation reaction on the molecules penetrating within them, appreciably reducing their acidity and thus their ability to attack the adhesive.

FIGS. 9 to 12 illustrate diagrammatically four possible methods of attachment between the product in FIG. 7 and that in FIG. 2. FIG. 9 shows the attachment illustrated in greater detail in FIG. 8.

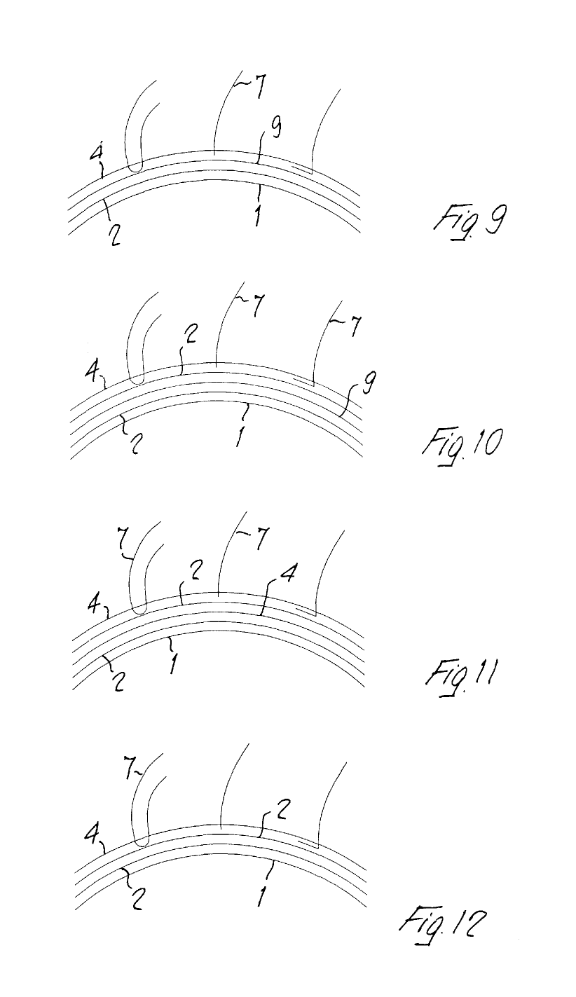

In the variant in FIG. 10, a layer of liquid polyurethane 9 is inserted between the product in FIG. 7 and that in FIG. 2. In a variant in FIG. 11 a polyurethane membrane 4 is inserted between the product in FIG. 7 and that in FIG. 2, and finally, in the variant in FIG. 12 liquid polyurethane film 9 in FIG. 9 is replaced by an adhesive membrane 2.

Of course this invention is not restricted to the embodiments illustrated and described, which are given purely by way of examples of the invention. Thus for example the product in FIG. 1 can instead be prepared using one or more uniform spread layers through the application of adhesive 2 to silicone film 1 in thin parallel threads separated by empty spaces, overlapping the sheets so prepared rotating them by 90° with respect to those beneath, obtaining a sandwich characterised by a weave of the fabric type comprising full parts and empty parts in which the full parts provide adhesion and the empty parts permit transpiration.

1. Method for the manufacture of a substrate which can be bonded to the skin in order to form self-adhesive hair prostheses through the use of a liquid adhesive, comprising the stages of:
adding 0% to 5.0% by weight of micronized silver powder or a stoichiometrically equivalent quantity of Ag⁺ ions to the adhesive,
intimately mixing the Ag powder and/or the Ag⁺ ions and the adhesive,
blowing microbubbles of air into that liquid mixture during the mixing stage,
spreading the mixture so obtained over a thermoformable quite easily or readily detached silicone film in thicknesses of 5 to 80 microns in a single spread layer.

2. Method according to claim 1, in which the said adhesive is an acrylic adhesive.

3. Method according to claim 2, comprising the subsequent stages of:
subsequently spreading the said mixture of adhesive and Ag onto the said thermoformable silicone film until thicknesses of between 100 and 400 microns are obtained,
applying a fairly easily or readily detachable silicone film to the film so obtained.

4. Method according to claim 3, comprising a further stage of heating the sandwich so formed to temperatures of the order of 60-80° C. in a male/female press reproducing the typical shape of the head, in such a way as to impart the shape of a cap.

5. Method according to claim 1, comprising the further stages of:
applying to that film a polyurethane membrane which has been rendered capable of transpiration through microperforation,
heating the sandwich so formed to temperatures of the order of 60-80° C. in a male/female press reproducing the standard shape of the head, in such a way as to impart the shape of a cap,
removing the thermoformable film and positioning it on a silicone head,
inserting hair into the said polyurethane membrane forming the hair prosthesis.

6. Method according to claim 5, in which after removal of the said prosthesis from the said head a layer of liquid polyurethane is spread onto the side of the prosthesis where the hair roots are located.

7. Method according to claim 3, in which the said acrylic adhesive is a liquid hypoallergenic ethyl acetate in a silicone base, or a hypoallergenic polyvinyl acetate in a water base.

8. Multi-layer adhesive prosthesis for hair obtained by joining the prosthesis mentioned in claim 5 to a substrate which can be bonded to the skin through the use of a liquid adhesive, comprising the stages of:
adding 0% to 5.0% by weight of micronized silver powder or a stoichiometrically equivalent quantity of Ag⁺ ions to the adhesive,
intimately mixing the Ag powder and/or the Ag⁺ ions and the adhesive,
blowing microbubbles of air into that liquid mixture during the mixing stage,
spreading the mixture so obtained over a thermoformable quite easily or readily detached silicone film in thicknesses of 5 to 80 microns in a single spread layer.
